(19) United States
(12) Patent Application Publication
(10) Pub. No.: US 2006/0150073 A1
(43) Pub. Date: Jul. 6, 2006

(54) Method for inhibiting the execution of a navigating command

(75) Inventor: Mikko K. Makela, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/026,528

(22) Filed: Dec. 30, 2004

(51) Int. Cl. G06F 17/24; G06F 9/44; G06F 17/21

(52) U.S. Cl. 715/501.1; 715/513; 717/115

(57) ABSTRACT

The present invention relates to the field of inhibiting a navigating command associated with an event and in particular to methods, devices and systems for handling such commands in an effective manner. The event generally controls the navigating to a certain item in an application environment is the method determines that the navigating command is to be executed. The method features checking if the navigating command would shift display to an area not actually displayed in the application environment; and in this case inhibiting the execution of the navigating command

### FIELD OF THE INVENTION

The present invention relates to the field of inhibiting a navigating command associated with an event in an application environment and in particular to methods, devices and systems for handling such commands in an effective manner. Said event generally controls the navigating to a certain item in an application environment.

### BACKGROUND OF THE INVENTION

For the sake of simplicity the following description is focused on JavaScript and its integration into a browser environment. However, the invention is not limited thereto and the focusing on JavaScript serves as a not-restricting example.

JavaScript is a simple programming language that may be used to embed commands into an HTML (HyperText Markup Language) document. HTML generally works in a static environment, wherein a user has to call up another web page to receive new information. Said call up occurs by clicking a link or by selecting another address in the browser for instance. HTML needs a bidirectional connection with a server, which then generates a new HTML page and sends it back to the user for displaying.

Thus, JavaScript was developed which offers higher flexibility than HTML but without the complexity of Java.

JavaScript shares the fundamental feature of all programming languages, for instance it can get data from some source, process that data, and output the results. Because JavaScript is integrated into the HTML environment, it already knows all the possible features of actually used browser, and can figure out, for example how many form elements are on a page or how many frames are in a window etc. It is also adapted to control this certain environment and can perform such tasks as targeting a specific frame for output or for input just as an ordinary user may target a frame to contain the contents of a hypertext link in HTML.

There is a large area wherein JavaScript may be included in designing web pages, i.e. for controlling a page; opening and closing windows and frames; programmatically accessing the history window (which allows a developer to refer to previously viewed documents) and other different browser features.

Due to running development of mobile devices, like mobile phones, PDA's or similar devices, the designing of web pages adapted to run on said devices becomes an important issue. A developer has to deal with limited hardware power or even with smaller displays, for instance with mobile phone displays which are substantially smaller than usual computer monitors.

JavaScript allows automatically navigating to a certain item belonging to a web page. By means of event driven programming, that is also included in the JavaScript language, a comfortable using of certain web pages may be implemented. Furthermore, JavaScript allows providing of feedback to the user, and generating of new HTML pages using variable information, and implement user-defined functions as well.

Because of the more restricted screen displays available on most mobile devices—as well as possible bandwidth issues—it may be appropriate to configure the content authoring environment with placeholders specifically intended for “mobile” content. For example, perhaps a company (TV station or newspaper) publishes detailed news articles on their site. For mobile devices it may be required to have separate placeholders for “condensed” versions of the content that will be more easily accommodated by mobile devices.

When downloading a web page, JavaScript may initially execute navigation to some element, like an input box (for example www.google.com does this with the search field; the cursor is in that field when a user selects said page). With small displays, the mentioned element often is not immediately visible on the display, and said element may not even comprise desired information.

### SUMMARY OF THE INVENTION

The object of the present invention is to provide a methodology, a device and a system for inhibiting the execution of a navigating command in an application environment, said command being associated with an event.

The objects of the present invention are solved by the subject defined in the accompanying independent claims.

According to a first aspect of the present invention, a method for inhibiting the execution of a navigating command in an application environment is provided. Said navigating is being associated with an event, wherein said event controls navigation to a certain item in said application environment. Said method further comprises the steps of determining that said navigating command is to be executed, checking if said navigating command would shift display to an area which is at least partly invisible in said browser environment and in this case inhibiting the execution of said navigating command. Thereby, no navigating command is executed which would shift to an area which is undisplayed or at least partly invisible, respectively, thereby avoiding inconvenience to the user. Thus an effective browsing of a web page in accordance with the present invention is provided, wherein the navigation of said web page is automatically done.

According to an embodiment of the present invention, said method also comprises the steps of launching said application, and selecting a document. Said launching of the application may be executed by user input, thus a specific navigating and using a document is enabled. Said document selection may be also provided by user input. Also imaginable is an automatic launching and selecting of said document or web page.

According to another embodiment of the present invention, said event is an onLoad Java/ECMAScript event, said onLoad event being executed during a loading of said web page in said browser. Thereby, controlling of said web page during initial loading is achieved. The onLoad routine and the methods within are executed before any other commands included in the Java/ECMAScript implementation. For instance, background color changes or the like may be executed thereby.

According to another embodiment of the present invention, said navigating is based on a select-Java/ECMAScript method. The select method allows navigating to a certain item, wherein a user input or the like may be provided. By means of a select method an input field may be selected by the implementation.

According to another embodiment of the present invention, said navigating is based on a focus-Java/ECMAScript method. Thus, a certain item within said browser environment may be focused.

According to another embodiment of the present invention, said JavaScript means are embedded within an HTML, XHTML, SMIL, Word, PowerPoint, AdobePDF document. Thereby, executable code is now embedded within HTML, XHTML, SMIL, Word, PowerPoint, AdobePDF content. Thus said content pages now become executable and they are not just passive.

According to another embodiment of the present invention, said event is a user input driven Java/ECMAScript event, said event detecting the user activity provided by means of a mouse, keyboard, touch screen or another input means. Hence, user behavior and input may be detected and further handled by the event handler inside of a possible implementation.

According to another embodiment of the present invention, said event is provided during a loading of a document in said application environment. Therewith controlling a document or a web page, respectively during initial loading is provided.

According to another aspect of the present invention, a computer program product is provided, comprising program code sections stored on a machine-readable medium for carrying out the operations of the aforementioned method according to an embodiment of the present invention, when the computer program product is run on a processor-based device, a computer, a terminal, a network device, a mobile terminal, or a mobile communication enabled terminal.

According to another aspect of the present invention, a software tool is provided. The software tool comprises program portions for carrying out the operations of the aforementioned methods when the software tool is implemented in a computer program and/or executed.

According to another aspect of the present invention, a computer data signal embodied in a carrier wave and representing instructions are provided which when executed by a processor causes the operations of the method according to an aforementioned embodiment of the invention to be carried out.

According to yet another aspect of the present invention, an electronic device adapted for inhibiting the execution of a navigating command in a browser environment is provided, said command being associated with an event based on JavaScript means, wherein said event controls navigation to a certain item in said browser environment.

The electronic device comprises a component for determining that said navigating command is to be executed, a component for checking if said navigating command will shift display to an area which is at least partly invisible in said application environment, a component for inhibiting the execution of said navigating command, and a central processing unit (CPU) being connected to said component for determining, component for checking, component for inhibiting, wherein said CPU is able to control all operational steps within said device, said CPU also interconnects all device modules.

According to another embodiment of the present invention, said electronic device further comprises a display for displaying, an input module, an output module and a transceiver for sending or receiving data. Thereby a device providing input and output component for a user is provided.

According to another embodiment of the present invention, said electronic device further comprises a wireless data interface adapted for data communication with said at least one network. Consequently, mobile communication with other entities is achieved.

According to another embodiment of the present invention, said electronic device further comprises a memory module adapted to store data. Said memory module may be used for storing different content or for internal controlling issues, for instance.

According to another embodiment of the present invention, a communication system comprising a plurality of remote entities and at least one electronic device is provided. Said electronic device is adapted for data communication with said plurality of remote entities.

According to another embodiment of the present invention, said data communication uses a HTTP interface.

According to another embodiment of the present invention, said data communication uses a Bluetooth interface.

According to another embodiment of the present invention, said data communication uses a UWB interface.

According to another embodiment of the present invention, said data communication uses a WLAN interface.

According to another embodiment of the present invention, said data communication uses a WAP interface.

Advantages of the present invention will become apparent to the reader of the present invention when reading the detailed description referring to embodiments of the present invention, based on which the inventive concept is easily understandable.

Throughout the detailed description and the accompanying drawings same or similar components, units or devices will be referenced by same reference numerals for clarity purposes.

Further, it is possible to use certain mark-up languages like XHTM or XFORMS, for instance to achieve the functionality in accordance with the present invention. However, XFORMS is adapted to provide a similar behavior that is reached by means of HTML with an embedded JavaScript part, without scripting.

Furthermore, any other methods may be used to set the display position or to place the focus in similar way like mentioned above, for instance by means of proprietary implementations.

The present invention is also applicable for browser applications or browsers, respectively in a PC-environment even if PC-displays are substantially larger than displays included in a mobile device. For instance, a user uses for the browser window only a small part of the display, thus the methodology in accordance with the present invention may be used.

It shall be noted that the designations portable device and mobile device are used synonymously throughout the description.

### SHORT DESCRIPTION OF THE DRAWINGS

The accompanying drawings are included to provide a further understanding of the invention, and are incorporated in and constitute a part of this specification. The drawings illustrate embodiments of the present invention and together with the description serve to explain the principles of the invention. In the drawings,

FIG. 1 shows a flow chart illustrating the principle of inhibiting a command in accordance with the present invention;

FIG. 2 emphasizes the meaning of a display area according to the present invention;

FIG. 3 depicts a exemplarily embodiment of a mobile device in accordance with the present invention; and

FIG. 4 illustrates a communication system having a plurality of server and at least one mobile device working on the basis of the present invention.

Even though the invention is described above with reference to embodiments according to the accompanying drawings, it is clear that the invention is not restricted thereto but it can be modified in several ways within the scope of the appended claims.

### DETAILED DESCRIPTION OF THE DRAWINGS

The invention may be embodied in a method and system for navigating web pages on a small screen device, as herein described with respect to the accompanying figures. Web pages or other documents may include any file that may be viewed over the Internet using a browser. These files include those created using HTML, XML, WAP, PQA, ASP, CGI, Java, JavaScript, and any other programming language or protocol that may be used to create and/or serve web pages over the Internet or another network.

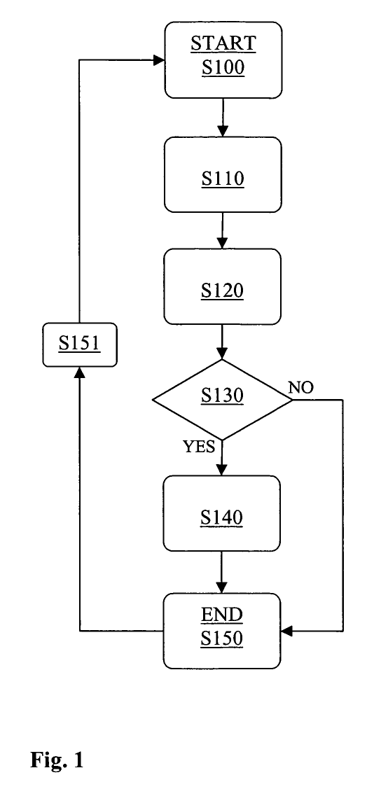

With reference to FIG. 1, a flow chart illustrating the principle of inhibiting a JavaScript command in accordance with the present invention is provided. The operational sequence starts in an operation S100. In an operation S110 a selecting of a desired web page is provided. Said web page having a HTML format and it includes a plurality of items.

For instance during said loading of the HTML page the JavaScript composer or event handler, respectively will execute the onLoad routine comprising desired commands. Usually the onLoad event comprises a number of commands described in the script part of said HTML page or in a separate script file. A programmer will use the script part of the HTML page for defining the behavior of the launched web page. Assuming that the onLoad event includes navigating commands like for instance a select method or the like, the browser or another application, respectively will navigate to an item or a position according to the select method or the like. The select method or the like describes which method or position is to be navigated.

In an operation S120 a checking if said navigating command would shift display to an area not actually displayed in said browser environment is provided. Because of browsing by means of a mobile device; the display is smaller than usual computer monitors. Thereby, a programmer wants to control the display focus or part of interest of the actual web page and for that a shifting operation of the displayed content may be provided. The shifting may be interpreted similar to a usual scrolling wherein a user actively controls the viewing field of a browser to get desired information.

If a shifting or navigation command under the above mentioned circumstances which is detected in an operation S130, a next operation S140 follows, corresponding to the YES branch the conditional operation S130. Operation S130 identifies the target of the navigating command, which has to be executed.

In an operation S140, inhibiting the execution of said navigating command is provided. This may mean that all navigating command defined in JavaScript are omitted under this certain circumstances.

If no further processing is carried out the method comes to an end at step S150 and it may be restarted in a new iteration represented by an operation S151.

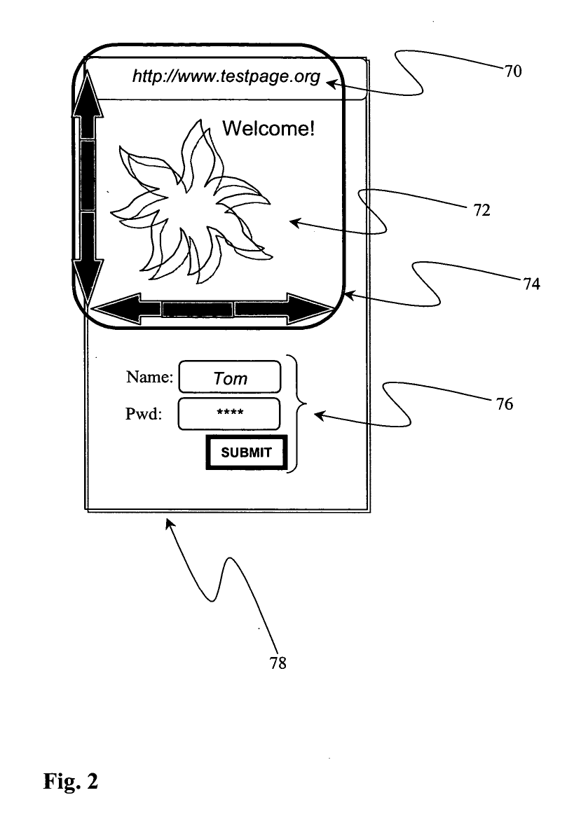

FIG. 2 illustrates the meaning of a display area in connection with a web page that is displayed on a portable device with a confined display, for instance. The display area 74 is able to display just a certain part of the whole web page 78. After the whole web page is loaded into the device from a server the user is able to scroll over the entire web page by means of usually known scrolling bars exemplarily depicted on the sides of the display area 74.

Said page 78 comprises a lot of items which are currently not depicted. Some of them are listed below: title 79, some exemplary content 72 and for instance some input items 76 used for user input. When the web page is loaded into the web browser only a part of said page can be displayed because of the confined size of the display area 74. Without any navigating commands a user will see only the items 72 while loading said web page.

JavaScript is enabled to manage the displayable content of a web page in a browser environment. JavaScript actions that happen automatically when a page loads are executed from “onload” event attribute. So, this functionality can be implemented in the following way: If JavaScript's “select” or “focus” method is executed in script code that was launched from “onLoad” event attribute, and method would navigate to on element that is not within initially displayed content, that method is ignored. Said ignoring may happen only partially for instance, because in some scripting/mark-up language the navigation command would also have some other effects in addition to moving the display/focus (for instance setting a value to a variable), so in that kind of case those other effects may or may not be ignored).

It is to be understood that defining whether the element, in which “select” or “focus” method refers, is initially visible or invisible may be defined many ways. It may be defined, for example, in a manner that it is considered to be visible, if it is fully visible, half of its area is visible, the cursor in that element is visible or at least 30% of it is visible in initial view. Further, it may be defined as invisible, if it is fully invisible, half of its area is invisible, the cursor in that element is invisible or at least 30% of it is invisible in initial view, as by example.

Note that the mentioned method does not necessarily need to be directly called from “onload” event attribute, but it can as well be in some method called from “onLoad” event attribute.

Script code executed from “onLoad” event attribute can trigger some other event attribute (like “onClick”) that can also cause navigation to element outside initially displayed part of the document. Also that navigation may be ignored.

Note also that the initially displayed part of the page is not necessarily the beginning of the page; for instance use of HTML document fragments may set initial display to be something different, and also normally when navigating back via navigation history the previous page is shown from previously viewed location.

Alternative implementation could be to ignore all automatic script related navigation commands on page load, which would solve the problem on normal web pages pretty well, but would limit functionality on mobile optimised pages (it is nice for instance on some mobile optimised log-in page to place cursor automatically to user name field, and on mobile optimised log-in pages those input fields normally fit to the first screen full on Series 60 size displays).

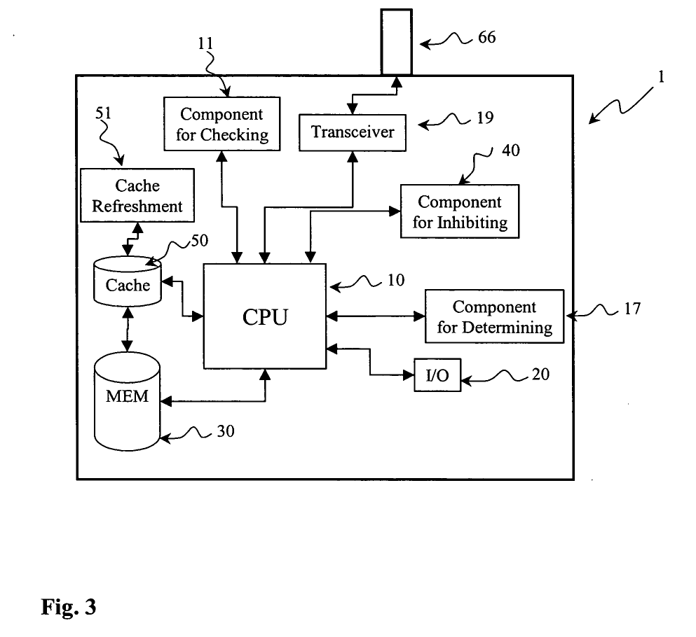

FIG. 3 illustrates an exemplarily embodiment of an electronic device adapted for inhibiting the execution of a navigating command in accordance with the present invention. The electronic device may be a mobile phone, a PDA, a PC, a game console or another imaginable electronic device.

Said device comprises at least one CPU, which may be adapted to control the entire functionality and all components included. Additionally, said device may comprise input and output means 20 like a keyboard and a display, for instance. An interface for connecting external I/O means is also imaginable because i.e. keyboards on mobile devices are often small and difficult to handle. All actions and operations inside may be triggered by means of a clock or similar device to ensure synchronization issues.

As a main component for said electronic device, a transceiver 19 is also designated interconnecting the at least one CPU. For proper communication an antenna 66 belonging to said transceiver 66 is used. Consequently, said device 1 is now enabled to communicate with different entities on a wireless basis. It is to be understood that communication with different entities may also be performed via wired connection.

For executing the above-mentioned methodology, a component for determining 17, a component for checking 11 and a component for inhibiting 40 are provided. Each of those components is connected to said at least one CPU as well and they are generally adapted to deal with JavaScript content. Another important component is the memory unit 30 and the cache unit 50 with its cache refreshment component 51. These components are used for the entire storage processes within the mobile device. They are adapted for storing all data needed by said at least one CPU temporarily or permanently.

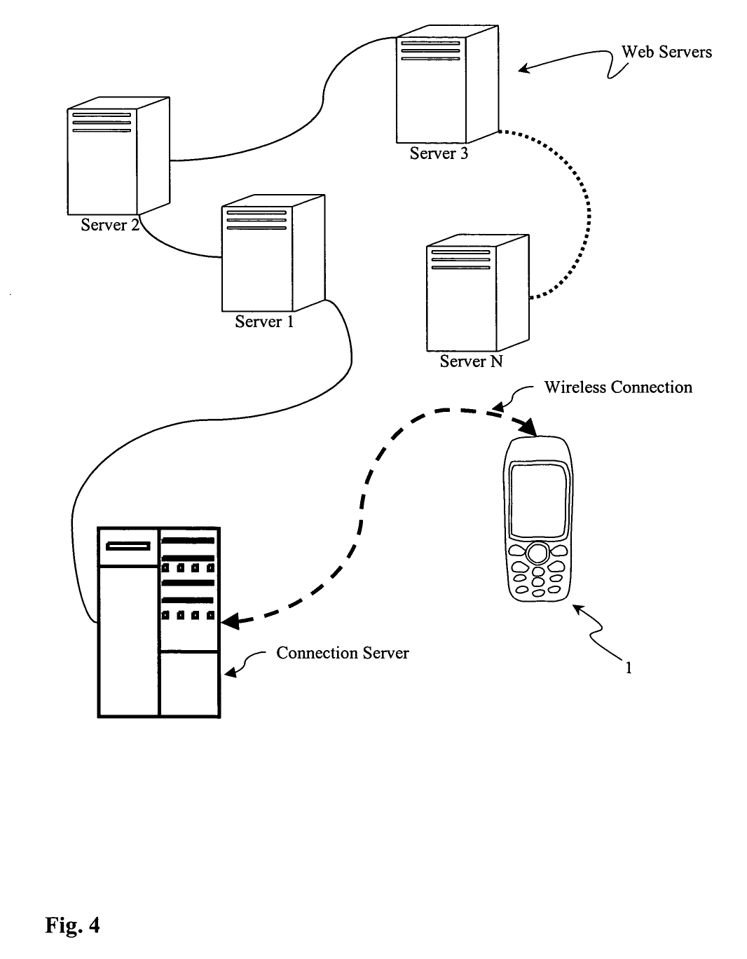

According to FIG. 4 a system comprising at least one mobile device 1 and a plurality of remote entities is illustrated. Said mobile device communicates in this exemplarily embodiment by means of an OTA (over-the-air) protocol. The Servers (1 to N) are web servers storing web related data like for example M-banking data or market information.

The mobile device 1 connects a connection server via OTA-protocol and the whole communication may happen by means of a wireless connection. The connection server manages and maintains connection related data and it is also adapted to establish the connection to the web servers or servers net, respectively. Thus, the mobile device is able to obtain information stored on any of the web servers 1 to N.

The client in form of said mobile device can connect directly to the servers of the network, without said intermediate connection server, for instance.

Further, it is clear that the documents may also be retrieved from a local storage, such as memory or a hard disk on the client (device) side. The documents correspond to the content, which a user wants to browse.

For instance, said mobile device loads a web page by means of a certain browser environment and said page is in HTML format also including JavaScript. The page is located on one of those servers and is now communicating with said mobile device 1. The JavaScript implementation is running on said device, wherein the original code was obtained from a server. Thereby, a cross platform implementation is achieved, wherein the servers and the plurality of mobile devices uses different OS.

The implementation of the logic diagram shown in FIG. 1 in form of an integrated circuit, an ASIC, a DSP, a FPGA or as a program comprising code sections for performing the illustrated logic rules is part of the knowledge of those skilled in the specific art.

Even though the invention is described above with reference to embodiments according to the accompanying drawings, it is clear that the invention is not restricted thereto but it can be modified in several ways within the scope of the appended claims.

What is claimed is:

1. A method for inhibiting the execution of a navigating command in an application environment, said navigating command being associated with an event, wherein said event controls navigation to a certain item in said application environment, comprising the steps of:
determining that said navigating command is to be executed;
checking if said navigating command would shift display to an area which is at least partly invisible in said application environment; and
if the checking step is affirmative, inhibiting the execution of said navigating command.

2. The method according to claim 1, further comprising the steps of:
launching said application; and
selecting a document.

3. The method according to claim 1, wherein said event is an onLoad Java/ECMAScript event, said onLoad event being executed during a loading of said document in said application.

4. The method according to claim 1, wherein said navigating is based on a select-Java/ECMAScript method.

5. The method according to claim 1, wherein said navigating is based on a focus-Java/ECMAScript method.

6. The method according to claim 1, wherein said Java/ECMAScript means are embedded within an HTML, XHTML, SMIL, Word, PowerPoint, AdobePDF document or the like.

7. The method according to claim 1, wherein said event is a user input driven Java/ECMAScript event, said event detecting the user activity provided by means of a mouse, keyboard, touch screen or another input means.

8. The method according to claim 1, wherein said event is provided during a loading of said document in said application environment.

9. A computer program product, comprising program code sections stored on a machine-readable medium for carrying out the steps of claim 1, when said program product is run on a processor-based device, a terminal device, a network device, a portable terminal, a consumer electronic device, or a mobile communication enabled terminal.

10. A software tool, comprising program portions stored on a readable medium for carrying out the operations of claim 1, when said program is implemented in a computer program for being executed on a processor-based device, a terminal device, a network device, a portable terminal, a consumer electronic device, or a mobile communication enabled terminal.

11. A computer data signal embodied in a carrier wave and representing instructions, which when executed by a processor cause the steps of claim 1 to be carried out.

12. An electronic device adapted for inhibiting the execution of a navigating command in an application environment, said command being associated with an event preferably based on Java/ECMAScript means, wherein said event controls navigation to a certain item in said application environment, said device comprising:
a component for determining that said navigating command is to be executed;
a component for checking if said navigating command will shift display to an area which is at least partly invisible in said application environment;
a component for inhibiting the execution of said navigating command; and
a central processing unit (CPU) being connected to said component for determining, said component for checking, and said component for inhibiting, wherein said CPU is adapted to control all operational steps within said device, said CPU also interconnecting all device modules.

13. The electronic device according to claim 13, further comprising:
a display for displaying;
an input module;
an output module;
a transceiver for sending and/or receiving data.

14. The electronic device according to claim 13, wherein said device further comprises a wireless data interface adapted for data communication with said at least one network.

15. The electronic device according to claim 13, wherein said device further comprises a memory module adapted to store data.

16. A communication system comprising a plurality of remote entities and at least one electronic device, said electronic device is adapted for data communication with said plurality of remote entities, wherein said electronic device corresponds to said electronic device according to claim 13.

17. The communication system according to claim 17, wherein said data communication uses a HTTP interface.

18. The communication system according to claim 17, wherein said data communication uses a Bluetooth interface.

19. The communication system according to claim 17, wherein said data communication uses a UWB interface.

20. The communication system according to claim 17, wherein said data communication uses a WLAN interface.

21. The communication system according to claim 17, wherein said data communication uses a WAP interface.
